(19) United States
(12) Patent Application Publication
(10) Pub. No.: US 2013/0050709 A1
(43) Pub. Date: Feb. 28, 2013

(54) SAGNAC INTERFEROMETER WITH BUNDLE-FIBER COIL

(71) Applicant: Ralph A. Bergh, Lititz, PA (US)

(72) Inventor: Ralph A. Bergh, Lititz, PA (US)

(21) Appl. No.: 13/695,858

(22) PCT Filed: May 2, 2011
(86) PCT No.: PCT/US11/34795

§ 371 Date: Nov. 2, 2012

Related U.S. Application Data
(60) Provisional application No. 61/330,381, filed on May 2, 2010.

(51) Int. Cl. G02B 6/26; G01C 19/72; G01B 9/02; G02B 6/255

(52) U.S. Cl. 356/465; 385/50; 385/95; 356/483

(57) ABSTRACT

A method in which a ribbon fiber, containing a plurality of waveguides each having a first end and a second end, is wound into a coil and the second end of a first waveguide is coupled together with the first end of a second waveguide such that light in said first waveguide will transfer to said second waveguide.

### RELATED APPLICATIONS

This application is related to U.S. provisional application No. 61/330,381, entitled “SAGNAC INTERFEROMETER WITH BUNDLE-FIBER COIL,” filed May 2, 2010, claims the priority thereof and incorporates that application by reference. This application is also related to International Patent Application PCT/US09/34140, having international filing date Feb. 13, 2009 to the same inventor here, entitled “AN INTERFEROMETER EMPLOYING A MULTI-WAVEGUIDE OPTICAL LOOP PATH AND FIBER OPTIC ROTATION RATE SENSOR EMPLOYING SAME,” and published under publication number WO2009/103015 on Aug. 20, 2009, all of the disclosure of which is incorporated by reference herein. International Patent Application PCT/US09/34140 includes and incorporates the disclosure of U.S. provisional application No. 61/028,688.

### TECHNICAL FIELD

The present invention relates, in general, to a Sagnac Interferometer, and more particularly one that is useful in a fiber optic rotation rate sensor, commonly referred to as a fiber optic gyroscope (FOG), employing a wound coil of many turns of a continuous optical fiber, defining an optical loop path, for passing a light wave therethrough.

### BACKGROUND OF THE DISCLOSURE

Reducing the size of the fiber gyroscope will increase the number of applications for which it is suitable. The purpose of this invention is to reduce the size of fiber optic gyroscopes (FOGs) without unduly sacrificing performance.

### BRIEF SUMMARY OF THE DISCLOSURE

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect of the invention, a method comprises winding a ribbon fiber into a coil, wherein the ribbon fiber includes a plurality of waveguides each having a first end and a second end; and coupling the second end of a first waveguide together with the first end of a second waveguide such that light in said first waveguide will transfer to said second waveguide.

In another aspect, light entering the first end of said first waveguide will pass once around the coil through said first waveguide and be transferred to said second waveguide and pass a second time around the coil.

In another aspect, the second end of the second waveguide is coupled together with the first end of a third waveguide and light will pass through the third waveguide and a third time around the coil.

In another aspect, the coil is part of a Sagnac interferometer.

In another aspect, the Sagnac interferometer is part of a fiber optic gyroscope.

In another aspect, a method comprises winding a bundle fiber into a coil, where the bundle fiber includes a plurality of waveguides each having a first end and a second end, and coupling the second end of a first waveguide together with the first end of a second waveguide such that light in said first waveguide will transfer to said second waveguide.

In another aspect, light entering the first end of said first waveguide will pass once around the coil through said first waveguide and be transferred to said second waveguide and pass a second time around the coil.

In another aspect, the second end of the second waveguide is coupled together with the first end of a third waveguide and light will pass through the third waveguide and a third time around the coil.

In another aspect, the coil is part of a Sagnac interferometer.

In another aspect, the Sagnac interferometer is part of a fiber optic gyroscope.

In yet another aspect, a method of using a ribbon fiber with a plurality of waveguides comprises winding the ribbon fiber into a coil and splicing a first waveguide to a second waveguide to form one continuous waveguide.

In another aspect, light entering one end of one of the waveguides will propagate around the coil twice in the same direction.

In another aspect, said second waveguide is spliced to a third waveguide to form one continuous waveguide.

In another aspect, light entering one end of the continuous waveguide will propagate around the coil a plurality of times in same direction each time in a different waveguide of the original ribbon fiber.

In another aspect, the continuous waveguide is part of a Sagnac interferometer.

In another aspect, the Sagnac interferometer is part of a fiber optic gyroscope.

In another aspect, a device comprises a ribbon fiber wound into a coil, wherein the ribbon fiber includes a plurality of waveguides each having a first end and a second end; wherein the second end of a first waveguide is coupled together with the first end of a second waveguide such that light in said first waveguide will transfer to said second waveguide.

In another aspect, light entering the first end of said first waveguide will pass once around the coil through said first waveguide and be transferred to said second waveguide and pass a second time around the coil.

In another aspect, the second end of the second waveguide is coupled together with the first end of a third waveguide and light will pass through the third waveguide and a third time around the coil.

In another aspect, the coil is part of a Sagnac interferometer.

In another aspect, the Sagnac interferometer is part of a fiber optic gyroscope.

### BRIEF DESCRIPTION OF THE DRAWINGS

While the novel features of the invention are set forth with particularity in the appended claims, the invention, both as to organization and content, will be better understood and appreciated, along with other objects and features thereof, from the following detailed description taken in conjunction with the drawings, in which:

FIG. 1-FIG. 1A schematically show fiber optic gyroscopes (FOGs) of the prior art, where a variety of optical components are shown including a source, detector, two directional couplers (dc1 & dc2), polarizer, phase modulator, and fiber coil.

FIG. 2a-FIG. 2d schematically show example configurations of fiber waveguide bundles in cross-sectional views. FIG. 3 schematically shows a fiber optic gyroscope with a bundle fiber in the coil.

FIG. 4 schematically shows an example of a partial winding of a ribbon fiber containing a plurality of waveguides into a quadrapole coil.

In the drawings, identical reference numbers identify similar elements or components. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DESCRIPTION OF THE PREFERRED EMBODIMENTS

The following disclosure describes several embodiments and systems for fiber optic gyroscopes. Several features of methods and systems in accordance with example embodiments are set forth and described in the Figures. It will be appreciated that methods and systems in accordance with other example embodiments can include additional procedures or features different than those shown in the Figures. Example embodiments are described herein with respect to wells. However, it will be understood that these examples are for the purpose of illustrating the principles, and that the invention is not so limited.

Additionally, methods and systems in accordance with several example embodiments may not include all of the features shown in these Figures. Throughout the Figures, identical reference numbers refer to similar or identical components or procedures.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one example” or “an example embodiment,” “one embodiment,” “an embodiment” or various combinations of these terms means that a particular feature, structure or characteristic described in connection with the embodiment is included in at least one embodiment of the present disclosure. Thus, the appearances of the phrases “in one embodiment,” “in an embodiment,” “in one example” or similar phrases in various places throughout this specification are not necessarily all referring to the same embodiment. Furthermore, the particular features, structures, or characteristics may be combined in any suitable manner in one or more embodiments.

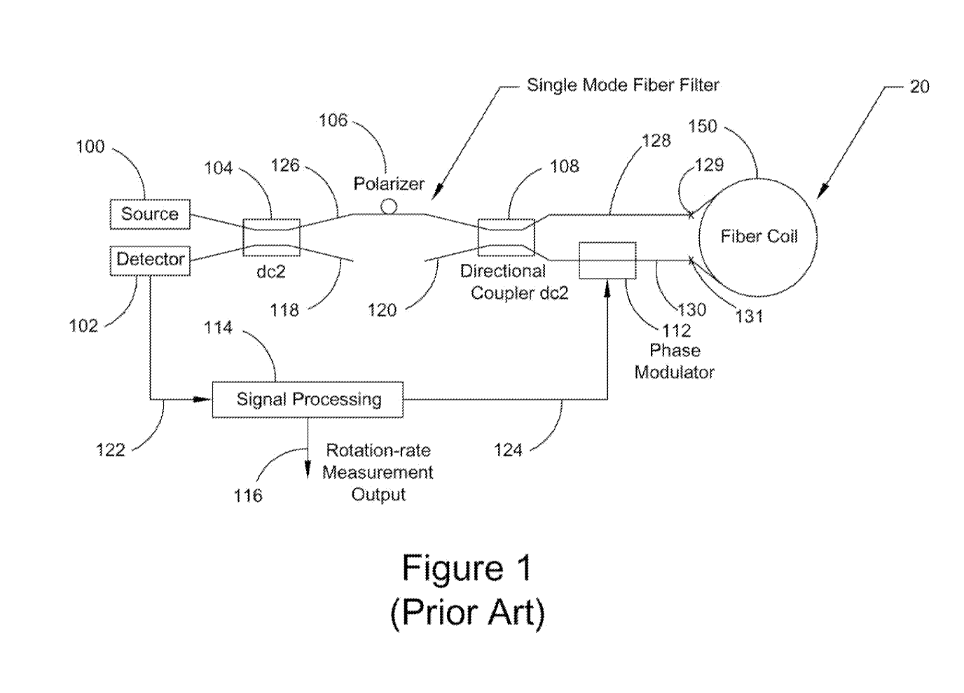

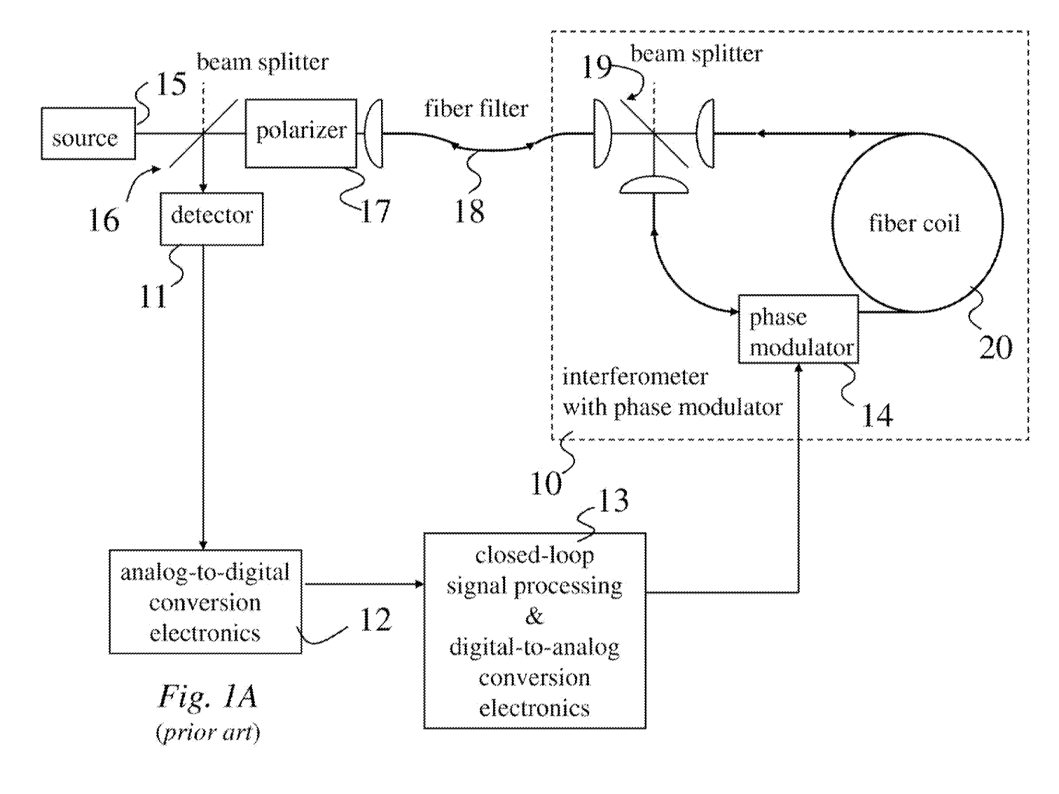

Fiber optic gyroscopes (FOGs) of the prior art are shown in FIG. 1 and FIG. 1A, where a variety of optical components are shown including a source, detector, two directional couplers (dc1 & dc2), polarizer, phase modulator, and fiber coil. Directional coupler, dc1, and loop of fiber make up the Sagnac interferometer used to detect rotation rate. The accuracy of the rotation rate measurement is improved by winding the loop of fiber in the interferometer into a multi-turn fiber coil. Electronics include analog-to-digital conversion electronics and signal processing as shown in FIG. 1A. The FOG in FIG. 1 is described in detail in International Patent Application PCT/US09/34140 and the FOG in FIG. 1A is described in detail in U.S. Pat. No. 7,505,139, issued Mar. 17, 2009, and entitled “SIGNAL PROCESSING FOR A SAGNAC INTERFEROMETER,” to Bergh, the inventor of the present disclosure, which is included herein by reference in its entirety.

The size of a FOG is determined by the size of its largest component, the coil of fiber in the interferometer. To reduce the size of the fiber coil without reducing the length of the optical fiber we must reduce the cross-sectional area devoted to a given waveguide. Reducing the cross-sectional area devoted to a given waveguide can be accomplished by reducing the diameter of the fiber. Unfortunately, smaller fiber is increasingly difficult to handle and increasingly difficult to wind into a precision wound fiber coil. To overcome this issue an idea was described to combine multiple waveguides into a single fiber structure so that multiple waveguides could be grouped together for ease of handling (see International Patent Application PCT/US09/34140). In the present invention, we specify a few types of multi-waveguide structures that would be compatible with winding a precision wound fiber coil.

In U.S. patent application 61/028,688, which was incorporated into International Application No. PCT/US09/34140, we described the use of multiple waveguides in single fiber structure that are wound together into a fiber coil. Each of the two ends are then combined together such that light inserted into one waveguide will pass through all of the waveguides, one after another until it emerges from the last waveguide and is removed from the coil.

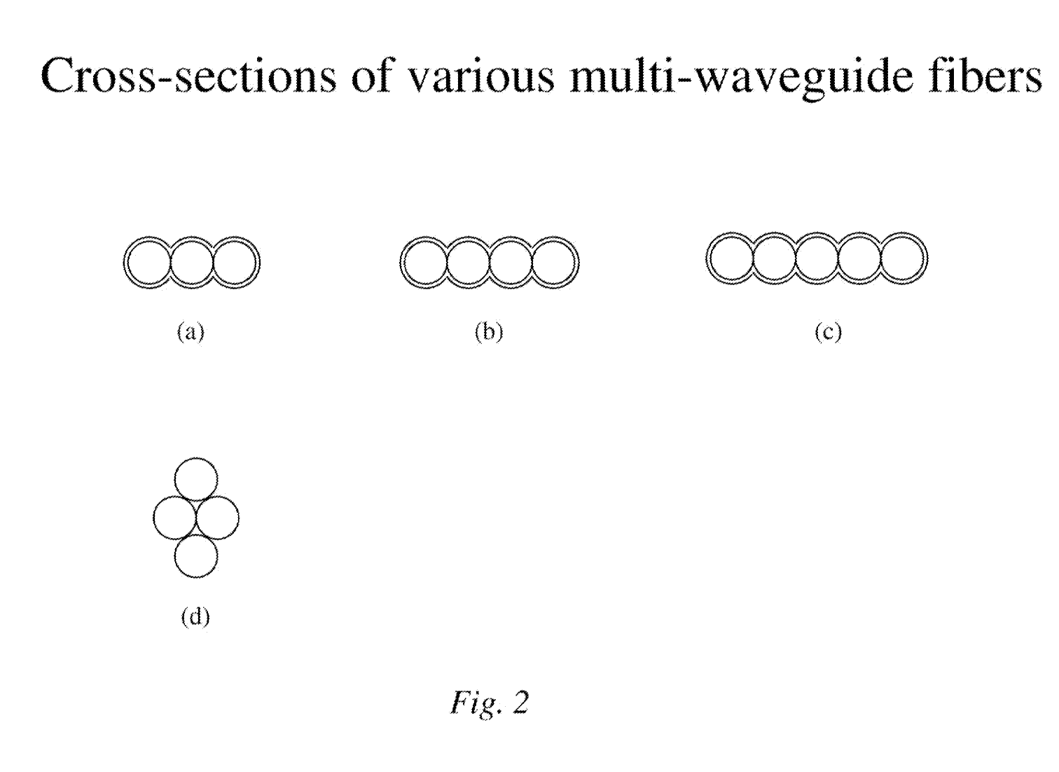

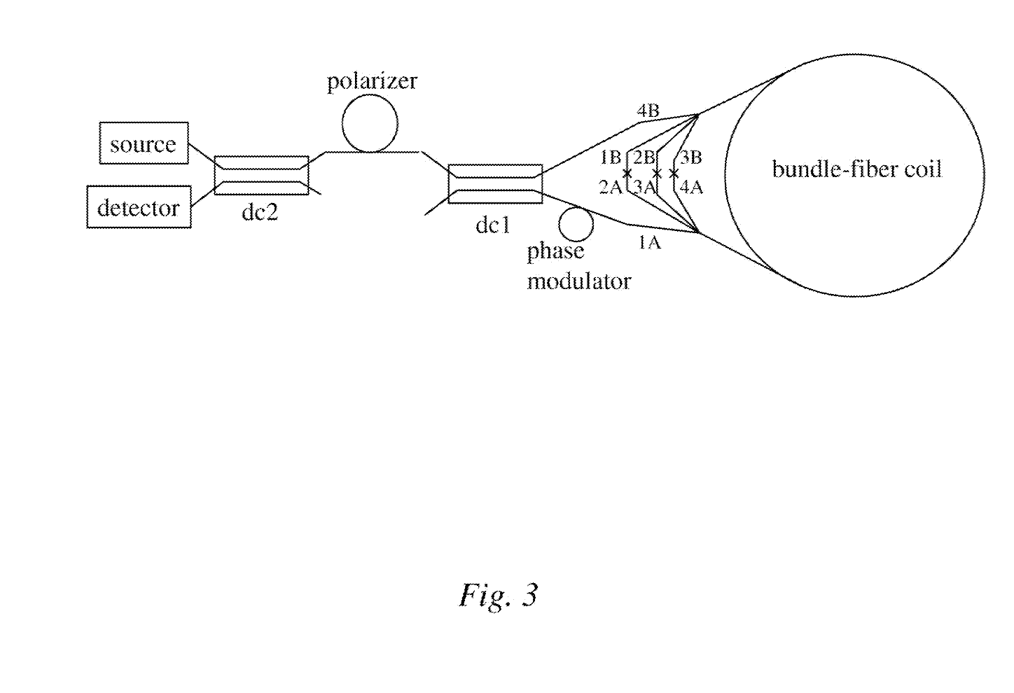

In the present invention we identify specific fiber waveguide bundles. In a preferred embodiment, a precision fiber coil is wound using ribbon fiber. A ribbon fiber might contain two or more parallel glass fibers in a row connected together with a polymer coating as shown in FIGS. 2a, 2b & 2c. Other types of fibers are possible, as shown in FIG. 2d, each containing a plurality of waveguides. These can be wound into a precision wound coil and after winding each end of the fiber can be separated into individual waveguides and spliced together so that the light will pass through all the fibers, one after another. A FOG with a bundle fiber in the coil is shown in FIG. 3.

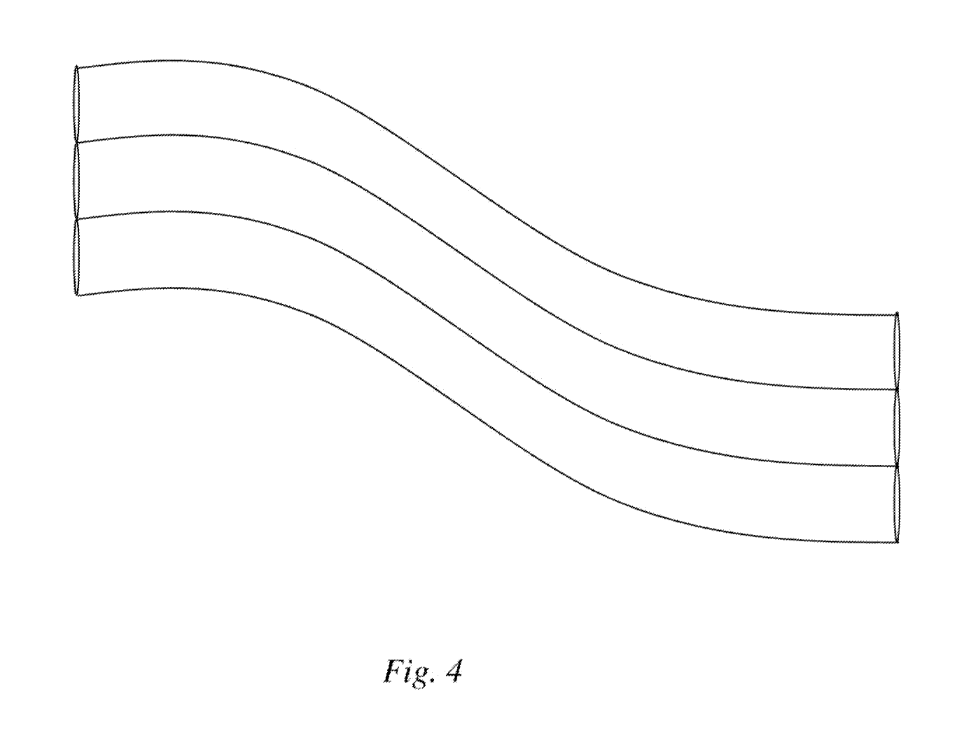

Still referring to FIG. 3, a bundle fiber (e.g. a ribbon fiber as shown in FIG. 4) is wound into a coil. The winding can take a variety of well known forms including quadrapole winding, octopole winding, hexadecapole winding, and interleave winding. If N fibers are wound together, then N-1 waveguides would be spliced together and to complete the fiber coil with two ends that will be delivered to a splitter/combiner to complete the interferometer. If we label the fibers 1,2,3, . . . , N-1, N, and we label one end of the bundle as the ‘A’ end and the other end of the bundle the ‘B’ end and the actual ends of the fibers to be 1A, 1B, 2A, 2B, 3A, . . . , NA, and NB, and we select 1A and NB to be the two fiber ends to be connected to the splitter/combiner then we can splice together ends 1B and 2A and we can splice together 2B and 3A and also 3B and 4A and so on until we splice together N-1B and NA, or in other words, N-1 splices are achieved (See FIG. 3).

Ribbon fiber can be used to make a precision-wound fiber coil with high packing density and low sensitivity to changes in the environment. Ribbon fiber consists of multiple parallel fibers arranged in a planar geometry and affixed, as shown in FIGS. 2a, 2b and 2c. Ribbon fiber is used in other applications, but it has not yet been applied to a FOG. It is possible to wind ribbon fiber into a precision-wound coil with high packing density. The advantages of this approach are ease of winding and reduced environmental sensitivity of the fiber coil.

Here is a description of winding a ribbon fiber containing three waveguides into a quadrapole coil. Beginning at the approximate center, the ribbon fiber is wrapped around a mandrel beginning with the first half of the ribbon fiber. After a single turn the ribbon containing the three waveguides is jogged to the side of the original turn and a second turn of ribbon is laid down right next to the original turn (see FIG. 4). A second turn of fiber is laid down and jogged to position the third turn of fiber. This continues until a complete layer of fiber is created. This is the same way a quadrapole winding is created with single waveguide fiber. The difference is that this is done with ribbon fiber containing three waveguides and each jog means that each fiber must jog three times as far as would be the case for a single waveguide fiber (See FIG. 4). A second layer is created from the second half of the ribbon fiber. The third layer is also created from the second half of the ribbon fiber. The fourth and fifth layers are created from the first half of the ribbon fiber, and the sixth and seventh layers from the second half, and so on until a desired integer multiple of four layers is achieved. The advantage of more fibers is the ease of winding the fiber into a coil.

The invention has been described herein in considerable detail in order to provide those skilled in the art with the information needed to apply the novel principles of the present invention, and to construct and use such exemplary and specialized components as are required. However, it is to be understood that the invention may be carried out by specifically different equipment, and devices, and that various modifications, both as to the equipment details and operating procedures, may be accomplished without departing from the true spirit and scope of the present invention.

What is claimed is:

1. A method comprising:
winding a ribbon fiber into a coil, wherein the ribbon fiber includes a plurality of waveguides each having a first end and a second end; and
coupling the second end of a first waveguide together with the first end of a second waveguide such that light in said first waveguide will transfer to said second waveguide.

2. The method of claim 1 wherein light entering the first end of said first waveguide will pass once around the coil through said first waveguide and be transferred to said second waveguide and passes a second time around the coil.

3. The method of claim 2 wherein the second end of the second waveguide is coupled together with the first end of a third waveguide and light will pass through the third waveguide and a third time around the coil.

4. The method of claim 1 wherein the coil is part of a Sagnac interferometer.

5. The method of claim 4 in which the Sagnac interferometer is part of a fiber optic gyroscope.

6. A method comprising winding a bundle fiber into a coil, where the bundle fiber includes a plurality of waveguides each having a first end and a second end, and coupling the second end of a first waveguide together with the first end of a second waveguide such that light in said first waveguide will transfer to said second waveguide.

7. The method of claim 6 wherein light entering the first end of said first waveguide will pass once around the coil through said first waveguide and be transferred to said second waveguide and passes a second time around the coil.

8. The method of claim 7 wherein the second end of the second waveguide is coupled together with the first end of a third waveguide and light will pass through the third waveguide and a third time around the coil.

9. The method of claim 6 wherein the coil is part of a Sagnac interferometer.

10. The method of claim 9 in which the Sagnac interferometer is part of a fiber optic gyroscope.

11. A method of using a ribbon fiber with a plurality of waveguides comprising:
winding the ribbon fiber into a coil and splicing a first waveguide to a second waveguide to form one continuous waveguide.

12. The method of claim 11 wherein light entering one end of one of the waveguides will propagate around the coil twice in the same direction.

13. The method of claim 12 wherein said second waveguide is spliced to a third waveguide to form one continuous waveguide.

14. The method of claim 13 wherein light entering one end of the continuous waveguide will propagate around the coil a plurality of times in same direction each time in a different waveguide of the original ribbon fiber.

15. The method of claim 13 in which the continuous waveguide is part of a Sagnac interferometer.

16. The method of claim 15 in which the Sagnac interferometer is part of a fiber optic gyroscope.

17. A device comprising:
a ribbon fiber wound into a coil, wherein the ribbon fiber includes a plurality of waveguides each having a first end and a second end; and
wherein the second end of a first waveguide is coupled together with the first end of a second waveguide such that light in said first waveguide will transfer to said second waveguide.

18. The device of claim 17 wherein light entering the first end of said first waveguide will pass once around the coil through said first waveguide and be transferred to said second waveguide and passes a second time around the coil.

19. The device of claim 18 wherein the second end of the second waveguide is coupled together with the first end of a third waveguide and light will pass through the third waveguide and a third time around the coil.

20. The device of claim 17 wherein the coil is part of a Sagnac interferometer.

21. The device of claim 20 in which the Sagnac interferometer is part of a fiber optic gyroscope.
